(19) United States
(12) Patent Application Publication
(10) Pub. No.: US 2020/0150728 A1
(43) Pub. Date: May 14, 2020

(54) HINGED DEVICE

(71) Applicant: Microsoft Technology Licensing, LLC, Redmond, WA (US)

(72) Inventors: Timothy G. ESCOLIN, Seattle, WA (US); Sheila A. LONGO, Seattle, WA (US); Logan MILLER, Monroe, WA (US); Mary T. LEE, Bellevue, WA (US); Michael F. DEILY, Bellevue, WA (US); Scott D. SCHENONE, Seattle, WA (US); Young S. KIM, Bellevue, WA (US)

(73) Assignee: Microsoft Technology Licensing, LLC, Redmond, WA (US)

(21) Appl. No.: 16/189,566

(22) Filed: Nov. 13, 2018

(51) Int. Cl. G06F 1/16

(52) U.S. Cl. CPC G06F 1/1681; G06F 1/1616; G06F 1/1669

(57) ABSTRACT

The description relates to devices that can include first and second portions. A virtual magnetic hinge assembly can rotationally secure the two portions yet a user can separate the device portions as desired. One example can include a first elongate magnetic hinge assembly encapsulated in a first end of the first portion and a second elongate magnetic hinge assembly encapsulated in a first end of the second portion. The first and second elongate magnetic hinge assemblies can bias the first ends together while allowing the first and second portions to be rotated through a range of rotations.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the FIG. and associated discussion where the reference number is first introduced. Where space permits, elements and their associated reference numbers are both shown on the drawing page for the reader's convenience. Otherwise, only the reference numbers are shown.

FIGS. 1A-2B and 2D-2I show perspective views of example devices in accordance with some implementations of the present concepts.

FIG. 2C shows an elevational view of an example device in accordance with some implementations of the present concepts.

### DESCRIPTION

The present concepts relate to devices that can rotate relative to one another. Magnetic hinge assemblies can be utilized to bias two devices or two device portions together so that they can be rotated relative to one another. The bias can be overcome by the user if the user wants to separate the devices/device portions and then the bias can automatically ‘snap’ the devices/portions together when the user positions them proximate to one another.

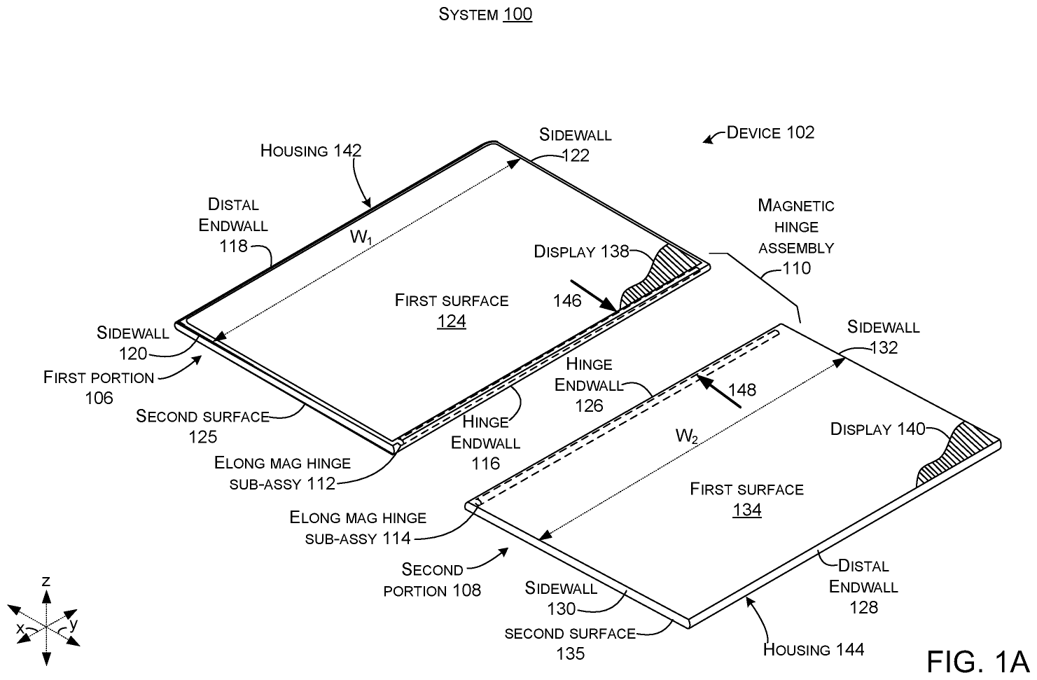

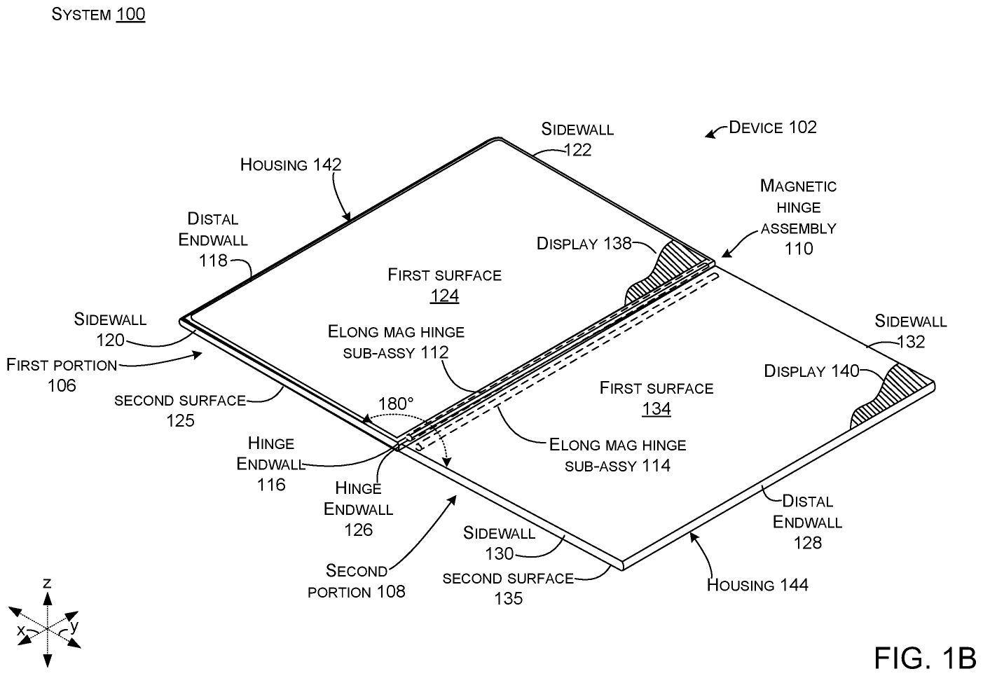

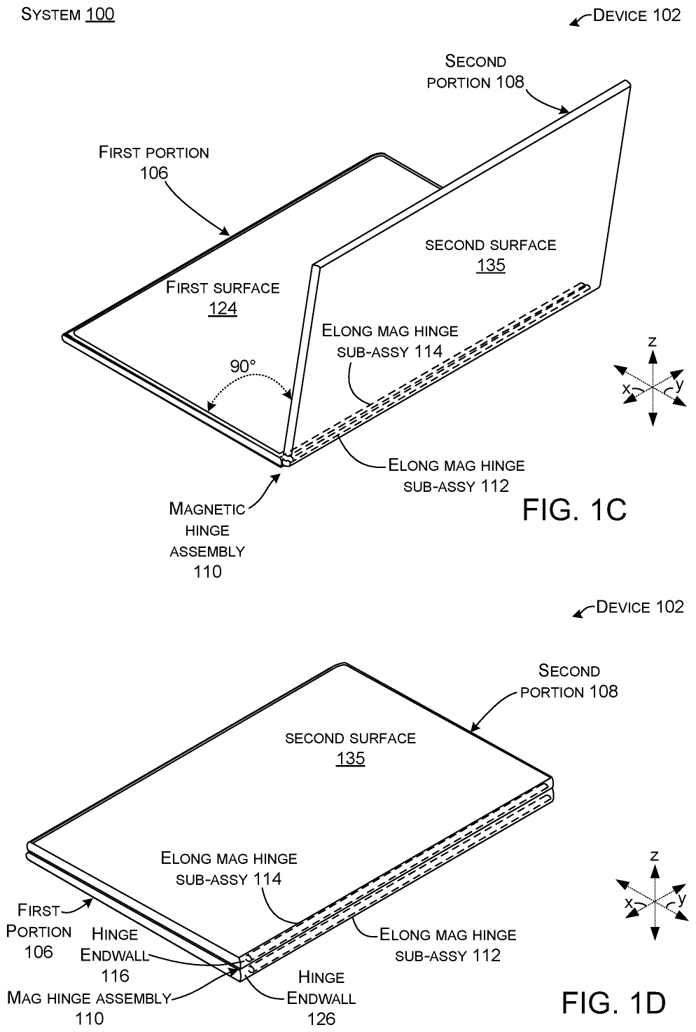

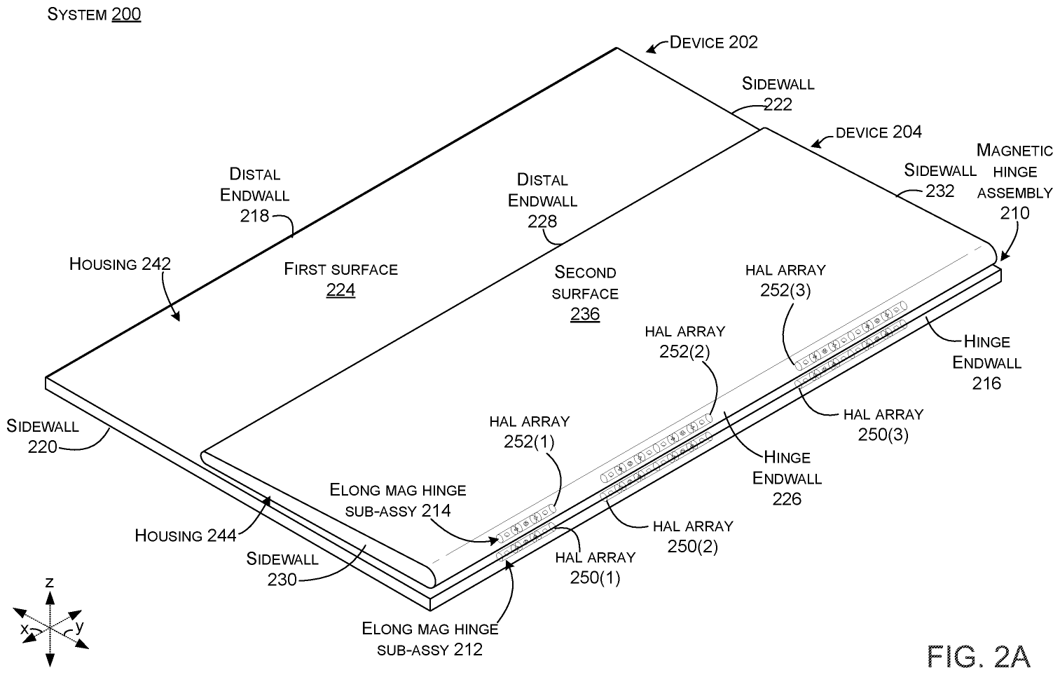

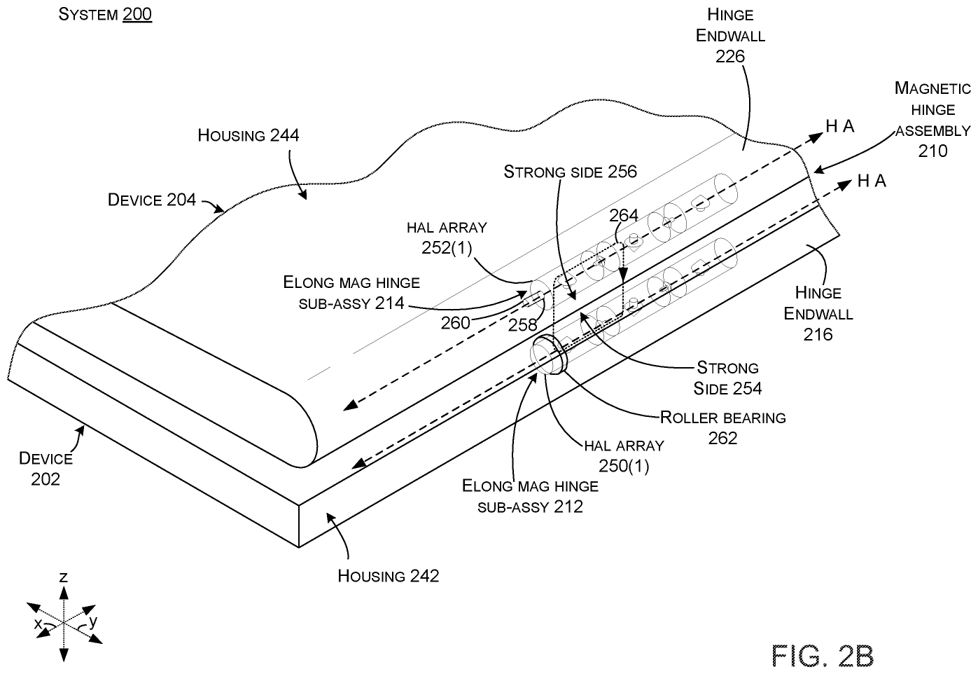

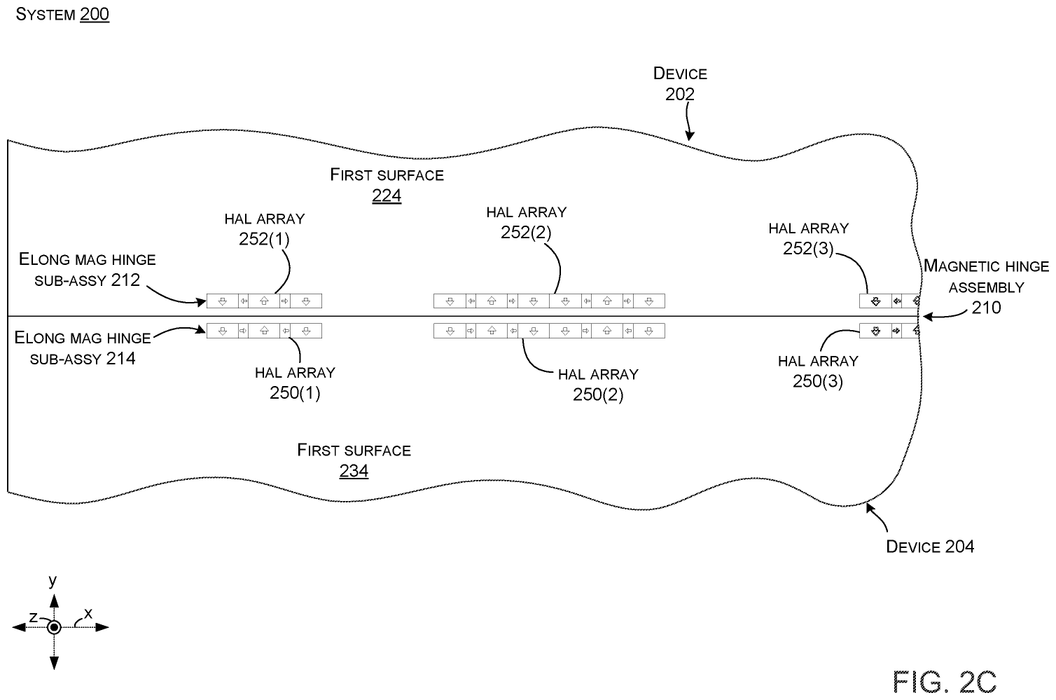

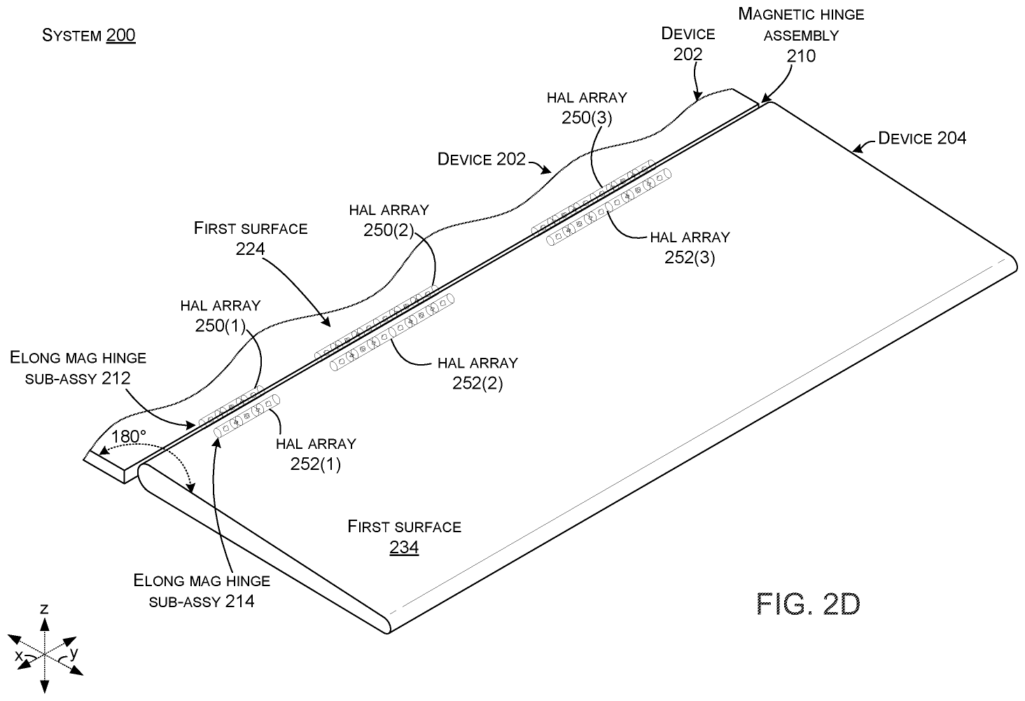

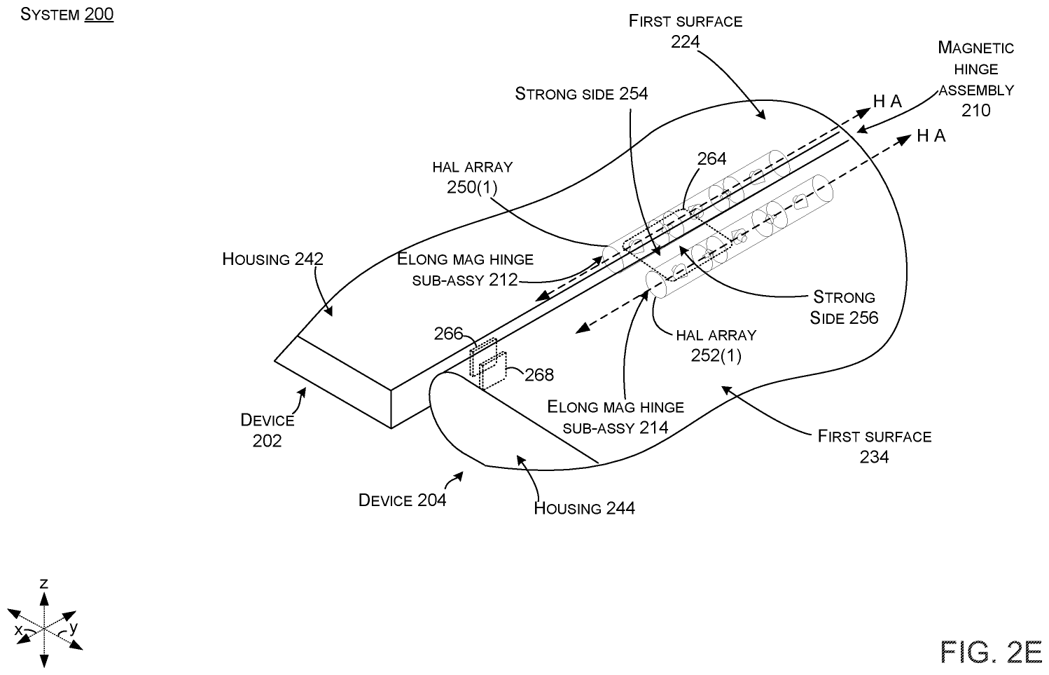

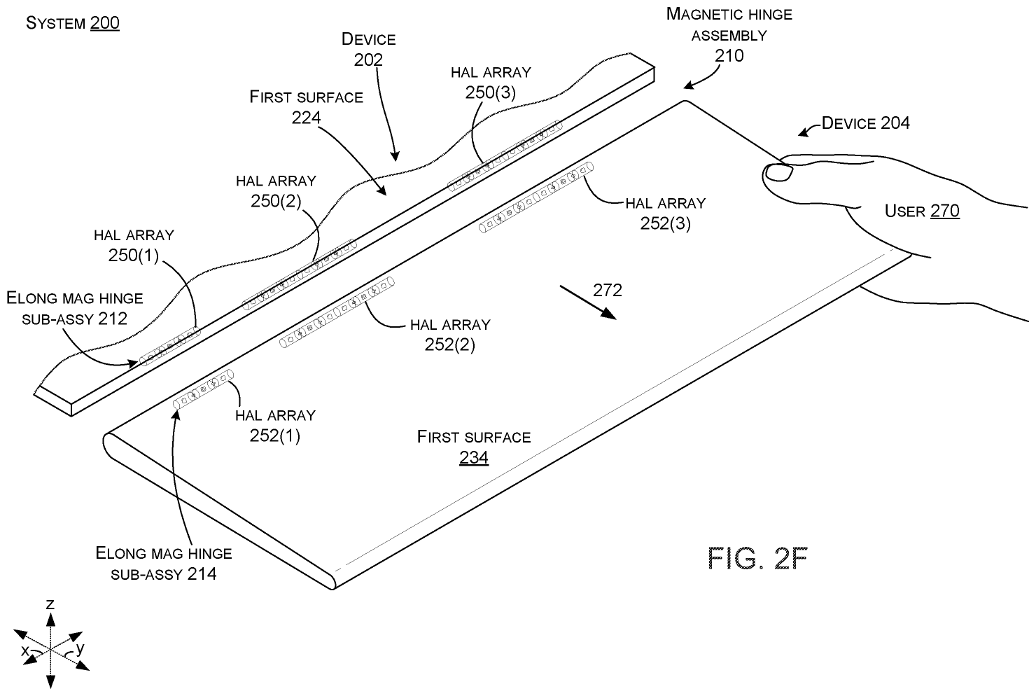

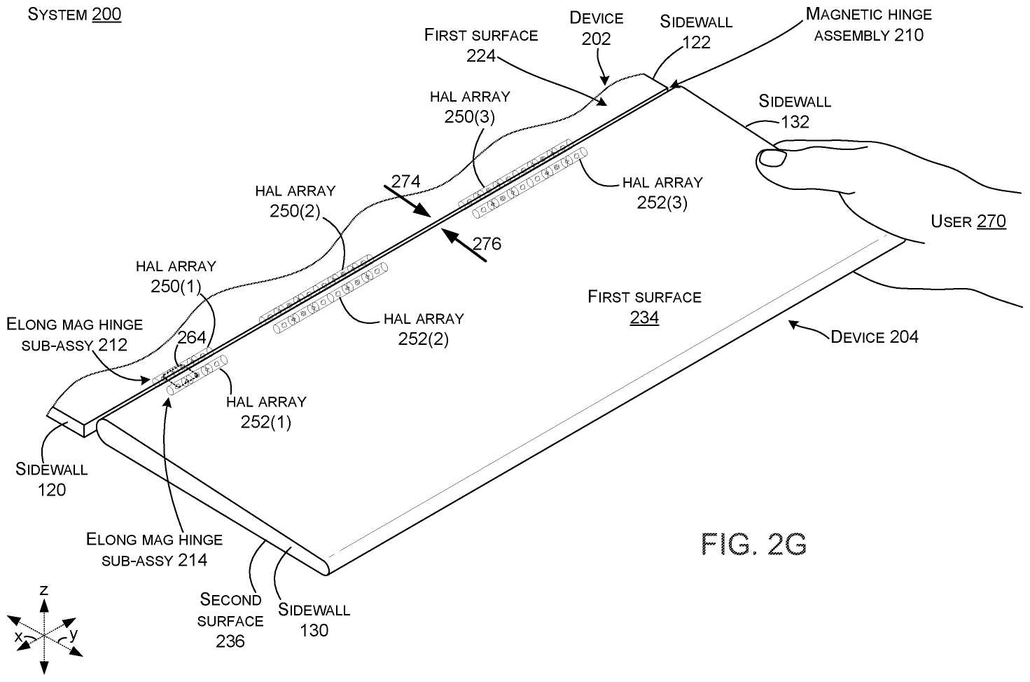

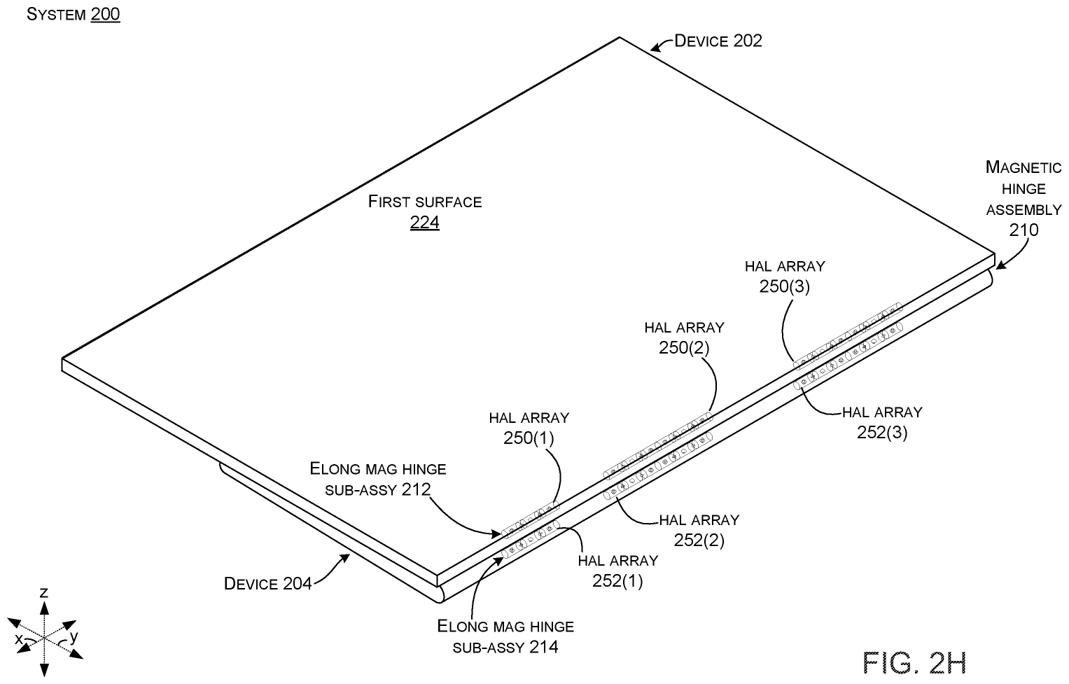

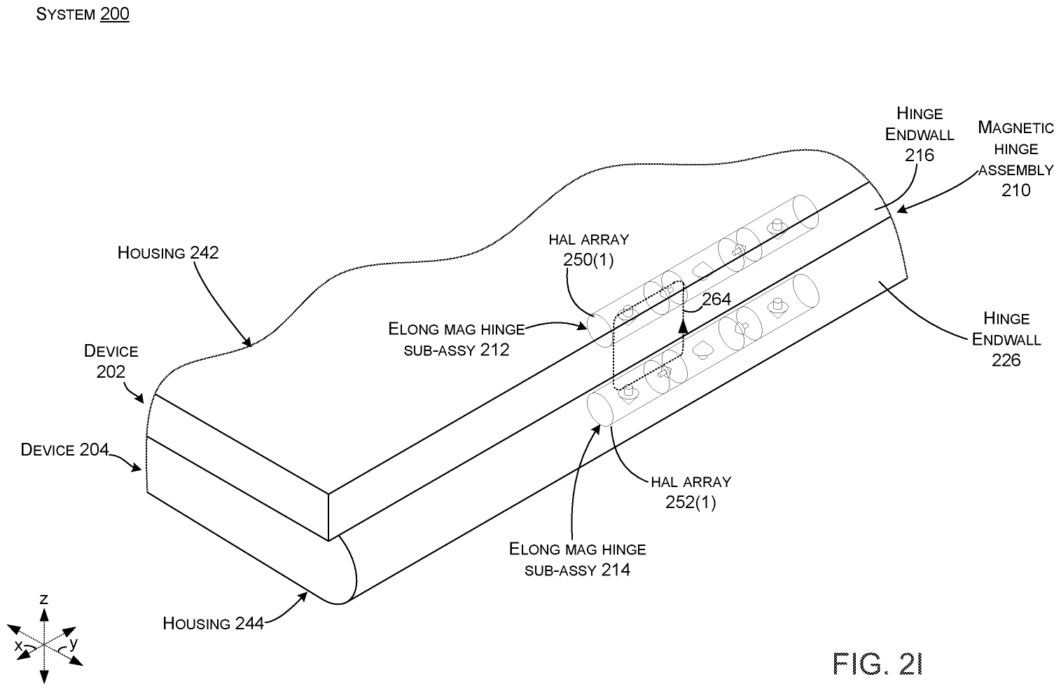

FIGS. 1A-1D collectively show an example system 100 that includes a device 102. The device can include first and second portions 106 and 108. The first and second portions can be removeably rotatably secured by a magnetic hinge assembly 110. The magnetic hinge assembly can include a first elongate magnetic hinge sub-assembly 112 positioned in the first portion 106 and a second elongate magnetic hinge sub-assembly 114 positioned in the second portion 108. In some implementations, the first elongate magnetic hinge sub-assembly 112 and the second elongate magnetic hinge sub-assembly 114 can have similar configurations. For instance, the first elongate magnetic hinge sub-assembly 112 and the second elongate magnetic hinge sub-assembly 114 could both include magnets. In another implementation, the first and second elongate magnetic hinge sub-assemblies could be dissimilar. For instance, the first elongate magnetic hinge sub-assembly 112 could include a magnet(s) and the second elongate magnetic hinge sub-assembly 114 could be a ferromagnetic material, such as iron, that is attracted to the magnets of the first sub-assembly. Various types of magnets can be utilized in the elongate magnetic hinge sub-assembly(s). For instance, axially magnetized magnets, diametrically magnetized magnets, and/or correlated magnets, among others can be employed. Additional elongate magnetic hinge sub-assembly details are described below relating to the implementations of FIGS. 2A-2I.

The first portion 106 can include a hinge endwall 116, a distal endwall 118 and/or first and second sidewalls 120 and 122. First and second opposing surfaces 124 (e.g., upwardly facing toward the reader) and 125 (e.g., downwardly facing away from the reader) can extend between the endwalls 116, 118 and the sidewalls 120, 122. The first portion 106 can have a width Wi defined between the two sidewalls 120 and 122.

The second portion 108 can include a hinge endwall 126, a distal endwall 128 and/or first and second sidewalls 130 and 132. First and second opposing surfaces 134 and 135 can extend between the endwalls 126, 128 and the sidewalls 130, 132. The second portion 108 can have a width W2 defined between the two sidewall 130 and 132.

In the present example, displays 138 and 140 are positioned on the first surfaces 124 and 134, respectively. In some cases, the first portion 106 can include a housing 142 that includes the first surface 124, second surface 125, sidewalls 120 and 122, hinge endwall 116, and/or distal endwall 118. Similarly, the second portion 108 can include a housing 144 that includes the first surface 134, second surface 135, sidewalls 130 and 132, hinge endwall 126, and/or distal endwall 128. In some cases, the displays 138 and 140 can be secured relative to the housings 142 and 144, respectively.

In this implementation, the elongate magnetic hinge sub-assemblies 112 and 114 can extend uniformly along the widths W₁ and W₂ or be distributed intermittently (see for example, FIGS. 2A-2I). In this implementation, the elongate magnetic hinge sub-assemblies 112 and 114 can be encapsulated within the first and second portions 106 and 108. For instance, the elongate magnetic hinge sub-assemblies 112 and 114 can be completely contained within housings 142 and 144, respectively so that there are no exposed elements of the magnetic hinge sub-assemblies. This configuration can have multiple potential advantages. For example, having the magnetic hinge sub-assemblies 112 and 114 encapsulated within the first and second portions 106 and 108 can prevent damage to the magnetic hinge sub-assemblies and/or prevent foreign materials from entering the first and second portions where they could interfere with the hinge function and/or cause other problems, such as short circuiting of electronic components. Further, exposed magnetic hinge sub-assembly elements are more exposed to contact damage, such as when inadvertently bumped into hard objects. Thus, this encapsulated configuration can enhance the reliability of the magnetic hinge assembly 110 and/or the reliability of the overall device 102. Encapsulating the magnetic hinge sub-assemblies 112 and 114 can also create an aesthetically pleasing device that enhances the user experience.

FIG. 1A shows the first and second portions 106 and 108 separated from one another. When the first and second portions are moved toward one another as indicated by arrows 146 and 148, the magnetic forces of elongate magnetic hinge sub-assemblies 112 and 114 will attract one another via magnetic fields and can bias the hinge endwalls 116 and 126 toward one another.

FIG. 1B shows first and second portions 106 and 108 oriented at about 180 degrees from one another. The magnetic forces of elongate magnetic hinge sub-assemblies 112 and 114 are biasing the hinge endwalls 116 and 126 of the first and second portions 106 and 108 against one another.

FIG. 1C shows first and second portions 106 and 108 rotated to an orientation of about 90 degrees from one another. The magnetic forces of elongate magnetic hinge sub-assemblies 112 and 114 are biasing the hinge endwalls 116 and 126 of the first and second portions 106 and 108 against one another during the rotation.

FIG. 1D shows first and second portions 106 and 108 rotated to an orientation of about zero degrees from one another (e.g., first surface 124 contacting first surface 134). Elongate magnetic hinge sub-assemblies 112 and 114 continue to bias the hinge endwalls 116 and 126 against one another.

FIGS. 1A-1D collectively show magnetic hinge assembly 110 can bias the hinge ends (e.g., hinge endwalls 116 and 126) against one another while allowing the first and second portions 106 and 108 to be rotated through a range of rotations (in this example 180 degrees to zero degrees). At any point, the user can pull the first and second portions apart as desired, such as to use them separately. As mentioned above, in some implementations, no hinge elements are visible to the user even the though first and second portions can rotate relative to one another. Further, the user can separate the device portions and use them individually. As such, from one perspective, the present magnetic hinge assembly implementations can be viewed as virtual hinges (e.g., the magnetic hinge assembly creates paired devices that function as though they are hinged together even though they are not mechanically connected and no hinge elements are visible and the user can separate and reattach the device portions at any time.

In this example, the hinge endwalls 116 and 126 are generally curved (e.g., circular) in profile when viewed transverse to the elongate magnetic hinge sub-assemblies 112 and 114. This curved profile is visualized in FIG. 1 D, among others. With the curved profile, the elongate magnetic hinge sub-assemblies 112 and 114 tend to remain at a generally consistent distance from one another (e.g., equidistance) during the rotation of the first and second portions 106 and 108. The curved profile can provide relatively consistent rotation of the two portions through the range of rotation without a strong bias toward particular orientations. An alternative configuration is discussed below relative to FIGS. 2A-2I.

FIGS. 2A-2I show another example system 200 that includes a device 202 that is removeably and rotatably coupled to a second device 204. In this example, device 202 is manifest as a tablet-type device and device 204 is manifest as an input device. The devices 202 and 204 can be removably rotatably secured by a magnetic hinge assembly 210. FIG. 2A shows device 202 and device 204 in a closed orientation. FIG. 2B is an enlarged view of a portion of FIG. 2A. FIGS. 2C and 2D show device 202 and device 204 oriented at 180 degrees. FIG. 2E shows an enlarged view of a portion of FIG. 2D. FIG. 2F shows a user overcoming the attraction of the virtual hinge to separate device 204 from device 202. FIG. 2G shows the user positioning device 204 proximate to device 202 such that magnetic attraction of the magnetic hinge assembly 210 can pull the devices back together. FIG. 2H shows the device rotated to a 360-degree orientation. FIG. 21 shows an enlarged view of a portion of FIG. 2H.

In this case, the magnetic hinge assembly 210 includes an elongate magnetic hinge sub-assembly 212 in the device 202 and another elongate magnetic hinge sub-assembly 214 in the device 204. In this implementation, the elongate magnetic hinge sub-assemblies 212 and 214 are manifest as arrangements of magnets in the form of Halbach arrays 250 and 252. Generally speaking, a Halbach array causes the magnetic field to be stronger on one side of the Halbach array than the other. In this particular implementation, Halbach arrays 250 are arranged into three groups (250(1), 250(2) and 250(3)). Group 250(1) is positioned proximate to sidewall 220, group 250(3) is positioned proximate sidewall 222, and group 250(2) is interposed in between. Also, in this implementation, the number of magnets in the first group 250(1) is dissimilar to the number in the third group 250(3). Similarly, group 252(1) is positioned proximate to sidewall 230, group 252(3) is positioned proximate sidewall 232, and group 252(2) is interposed in between. Also, in this implementation, the number of magnets in the first group (252(1) is dissimilar to the number in the third group 252(3), but the numbers in groups 250(1) and 252(1) and 250(3) and 252(3) tend to match. The Halbach arrays 250, 252 create a collective strong magnetic force (e.g., strong side 254 and 256) and an opposite weak magnetic force (weak side).

In some implementations, the Halbach arrays 250 and 252 can rotate around the respective hinge axes (HA, FIG. 2B). For instance, in some implementations, the Halbach arrays can have a hole 258 formed along the hinge axis and a hinge pin 260 that is coextensive with the hinge axis can pass through the hole so the Halbach arrays can rotate around the hinge axis (e.g., relative to the housing 242, 244 of the respective devices 202, 204). (Hole 258 and hinge pin 260 are shown relative to Halbach arrays 252(1) in FIG. 2B). In other implementations, the Halbach arrays can be nested in a roller bearing 262 (FIG. 2B, relative to Halbach arrays 250(1)) so that the Halbach arrays can rotate relative to the housing of the respective devices. This ability of the Halbach arrays to rotate relative to the devices allows the Halbach arrays of devices 202 and 204 to maintain high (and potentially maximum) magnetic attraction through the range of orientations of the devices.

Stated another way, the Halbach arrays 250(1) of the device 202 can pair with Halbach arrays 252(1) of input device 204 as represented at 264. This pairing can maximize the magnetic forces between the two sets of Halbach arrays. The Halbach arrays of the device 202 and the Halbach arrays of the device 204 can maintain this pairing (and the same relative orientation) through the entire range of rotation of the devices. Thus, the devices remain rotationally secured to one another (e.g., don't separate during use), but can be easily separated by the user if desired.

In this example, the device 202 and/or device 204 can include mechanisms for biasing the devices to specific relative orientations. For instance, in the illustrated implementation, the hinge endwall 216 of device 202 has a rectangular profile and the hinge endwall 226 of input device 204 has a rounded profile. Thus, during rotation of the devices the distance between the hinge axes changes. This combination can bias the devices toward specific orientations (e.g., those where the hinge axes are closer together), such as zero degrees (FIGS. 2A and 2B) and 180 degrees (FIGS. 2C-2E). Other mechanisms, such as positional magnets 266 and 268 (FIG. 2E) in the device 202 and the device 204 can provide and/or augment the bias.

FIGS. 2A and 2B show the devices 202 and 204 in a closed orientation with device 204 positioned on device 202. Magnetic hinge assembly 210 provides magnetic forces that biases the hinge endwalls 216 and 226 toward one another. The Halbach arrays 250 and 252 are paired as indicated at 264 to create a stronger magnetic force between the two devices than can be obtained with other magnet configurations (for a given magnet diameter).

FIGS. 2C-2E show the devices 202 and 204 rotated around magnetic hinge assembly 210 to a 180-degree orientation. Note that the Halbach arrays 250 have rotated independently of device 202 and Halbach arrays 252 have rotated independently of device 204. Thus, even though the relative orientations of the devices have changed from the zero-degree orientation of FIGS. 2A and 2B, the relative orientations of the Halbach arrays remains unchanged in the paired state. Thus, the Halbach arrays 250 and 252 can continue to provide (nearly) maximum attractive magnetic forces while the devices 202 and 204 are rotated through a range of orientations. This aspect is further evidenced relative to FIGS. 2H and 21.

FIG. 2F shows user 270 pulling the devices 202 and 204 apart by applying a force represented by arrow 272 that overcomes the magnetic forces of the magnetic hinge assembly 210. In some implementations, no elements of the magnetic hinge assembly 210 are visible to the user and the devices 202 and 204 can be used independently in a traditional manner. There are no visible hinge elements and the user does not have to operate any mechanisms to separate the two devices. As such the magnetic hinge assembly 210 can be viewed as a virtual hinge (e.g., the magnetic hinge assembly can be hidden yet provide hinge functionality to the two devices and the user can rotate and/or separate the devices as desired).

FIG. 2G shows the user 270 positioning the devices 202 and 204 proximate to each other such that the magnetic hinge assembly 210 can bias the devices against one another at their hinge ends as indicated by arrows 274 and 276. Note that because the elongate magnetic hinge sub-assemblies 212 and 214 can rotate independently of their respective devices, the Halbach arrays 250 and 252 can rotate and re-pair as indicated at 264. Recall that the pairing can provide greater magnetic forces between the devices than may otherwise be possible.

Note also, that this implementation creates greater magnetic attraction when the devices 202 and 204 are properly oriented as detailed below. In this case, the Halbach arrays 250 and 252 are positioned asymmetrically along the hinge axes rather than uniformly. This can create stronger magnetic attraction for one device orientation than another (e.g., stronger magnetic attraction when first surfaces 224 and 234 facing one another and second surfaces 225 and 235 facing one another than vice versa). For instance, as mentioned above the number of magnets in the first group of Halbach array 250(1) corresponds to (e.g., complements) the number in the first group of Halbach array 252(1). Similarly, the number of magnets in the third group of Halbach array 250(3) corresponds to (e.g., complements) the number in Halbach array 252(3), but the number is different than those of Halbach arrays 250(1) and 252(1). Further, Halbach arrays 250(1) and 252(1) are a different distance from sidewalls 120 and 130 than Halbach arrays 250(3) and 252(3) are from sidewalls 122 and 132. For either or both of these reasons if the user rotates device 204 180 degrees around the y-reference axis, the magnetic attraction is diminished. This diminished magnetic attraction can function as feedback (e.g., an indicator) for the user that the two devices are not positioned properly relative to one another.

FIGS. 2H and 2I show the re-attached device 204 rotated under device 202 (e.g., 360 degrees of rotation relative to the zero-degree orientation of FIGS. 2A and 2B). As noted above, the ability of the elongate magnetic hinge sub-assemblies 212 and 214 to rotate independently of the devices can allow the respective Halbach arrays 250 and 252 to maintain a relatively strong (potentially maximum) magnetic field throughout the range of rotation (e.g., in this case, 360 degrees of relative rotation) between the two devices 202 and 204. As such, the magnetic hinge assembly 210 can provide an ‘invisible’ hinge functionality for the two devices that also allows the user to separate the devices as desired. This functionality can be accomplished in very small form factors. For instance, the thickness of the devices (e.g. as measured in the z-reference direction) can be less than half a centimeter with the thickness of the elongate magnetic hinge sub-assemblies occupying about one-half of the thickness (e.g., about a quarter of a centimeter or less) while still providing strong enough magnetic forces for effective hinge functionality (e.g., devices do not separate during normal use unless separated by the user).

The present device concepts can be utilized with any type of hinged devices, such as but not limited to notebook computers, smart phones, wearable smart devices, tablets, and/or other types of existing, developing, and/or yet to be developed devices.

Various methods of manufacture, assembly, and/or use for these hinged devices and/or associated input devices are contemplated beyond those shown above relative to FIGS. 1A-2I.

Although techniques, methods, devices, systems, etc., pertaining to hinged devices and associated input devices are described in language specific to structural features and/or methodological acts, it is to be understood that the subject matter defined in the appended claims is not limited to the specific features or acts described. Rather, the specific features and acts are disclosed as example forms of implementing the claimed methods, devices, systems, etc.

Various device examples are described above. Additional examples are described below. One example includes a device comprising a first portion associated with a first elongate magnetic hinge assembly comprising a first Halbach array arranged along a first axis that passes through the first portion and a second portion associated with a second elongate magnetic hinge assembly comprising a second Halbach array arranged along a second axis that passes through the second portion and is parallel to the first axis, magnetic fields between the first Halbach array and the second Halbach array biasing the first and second portions against one another such that the first and second portions can be rotated through a range of relative orientations while the first Halbach array and the second Halbach array maintain a same orientation to one another by rotating around the first and second axes.

Another example can include any of the above and/or below examples where the first axis and the second axis remain equidistance apart during the range of relative orientations of the first and second portions.

Another example can include any of the above and/or below examples where a distance between the first axis and the second axis changes during the range of relative orientations.

Another example can include any of the above and/or below examples where the device further comprises a first hinge pin that passes through the first Halbach array along the first axis.

Another example can include any of the above and/or below examples where the device further comprises a second hinge pin that passes through the second Halbach array along the second axis.

Another example can include any of the above and/or below examples where rotation of the first Halbach array around the first hinge pin and the second Halbach array around the second hinge pin maintains the same orientation during the range of relative orientations of the first portion and the second portion.

Another example can include any of the above and/or below examples where the first portion extends along a first width measured parallel to the first axis and the second portion extends along a second width that extends parallel to the second axis.

Another example can include any of the above and/or below examples where the first Halbach array comprises multiple Halbach arrays that are positioned uniformly along the first width and the second Halbach array comprises multiple different Halbach arrays that are positioned uniformly along the second width.

Another example can include any of the above and/or below examples where the first Halbach array comprises multiple Halbach arrays that are positioned asymmetrically along the first width and the second Halbach array comprises multiple different Halbach arrays that are positioned asymmetrically and complementary along the second width.

Another example can include any of the above and/or below examples where the first portion comprises opposing first and second surfaces that extend from a first sidewall to a second sidewall and the second portion comprises opposing first and second surfaces that extend from a first sidewall to a second sidewall.

Another example can include any of the above and/or below examples where the first Halbach array is arranged in a first group proximate to the first sidewall of the first portion and a second group proximate to the second sidewall of the first portion and the second Halbach array is arranged in a first group proximate to the first sidewall of the second portion and a second group proximate to the second sidewall.

Another example can include any of the above and/or below examples where the first group of the first portion and the first group of the second portion are complementary and the second group of the first portion and the second group of the second portion are complementary.

Another example can include any of the above and/or below examples where the first group of the first portion and the first group of the second portion are dissimilar to the second group of the first portion and the second group of the second portion.

Another example can include any of the above and/or below examples where magnetic forces between the first portion and the second portion are greater when the first surface of the first portion is aligned with the first surface of the second portion than when the first surface of the first portion is aligned with the second surface of the second portion.

Another example includes a device comprising a first portion that includes a first elongate magnetic hinge assembly encapsulated in a first end of the first portion, a second portion that includes a second elongate magnetic hinge assembly encapsulated in a first end of the second portion, and the first and second elongate magnetic hinge assemblies biasing the first ends together while allowing the first and second portions to be rotated through a range of rotations.

Another example can include any of the above and/or below examples where the first elongate magnetic hinge assembly comprises a magnet and the second elongate magnetic hinge assembly comprises a magnet or wherein the first elongate magnetic hinge assembly comprises a magnet and the second elongate magnetic hinge assembly comprises a ferromagnetic material.

Another example can include any of the above and/or below examples where the first elongate magnetic hinge assembly comprises first correlated magnets and the second elongate magnetic hinge assembly comprises second correlated magnets.

Another example can include any of the above and/or below examples where a profile of the first portion when viewed transverse to the first elongate magnetic hinge assembly is the same as a profile of the second portion when viewed transverse to the second elongate magnetic hinge assembly.

Another example can include any of the above and/or below examples where a profile of the first portion when viewed transverse to the first elongate magnetic hinge assembly is different than a profile of the second portion when viewed transverse to the second elongate magnetic hinge assembly.

Another example includes a device comprising a first device that includes a first elongate magnetic hinge assembly that is rotationally secured proximate to a first end of the first device, a second device that includes a second elongate magnetic hinge assembly proximate to a first end of the second device, and the first and second elongate magnetic hinge assemblies configured to create a magnetic force that biases the first ends together while allowing the first and second devices to be rotated through a range of rotations while the first elongate magnetic hinge assembly rotates independently of the first device.

1. A device, comprising:
a first portion associated with a first elongate magnetic hinge assembly comprising a first Halbach array arranged along a first axis that passes through the first portion; and,
a second portion associated with a second elongate magnetic hinge assembly comprising a second Halbach array arranged along a second axis that passes through the second portion and is parallel to the first axis, magnetic fields between the first Halbach array and the second Halbach array biasing the first and second portions against one another such that the first and second portions can be rotated through a range of relative orientations while the first Halbach array and the second Halbach array maintain a same orientation to one another by rotating around the first and second axes.

2. The device of claim 1, wherein the first axis and the second axis remain equidistance apart during the range of relative orientations of the first and second portions.

3. The device of claim 1, wherein a distance between the first axis and the second axis changes during the range of relative orientations.

4. The device of claim 1, further comprising a first hinge pin that passes through the first Halbach array along the first axis.

5. The device of claim 4, further comprising a second hinge pin that passes through the second Halbach array along the second axis.

6. The device of claim 5, wherein rotation of the first Halbach array around the first hinge pin and the second Halbach array around the second hinge pin maintains the same orientation during the range of relative orientations of the first portion and the second portion.

7. The device of claim 1, wherein the first portion extends along a first width measured parallel to the first axis and the second portion extends along a second width that extends parallel to the second axis.

8. The device of claim 7, wherein the first Halbach array comprises multiple Halbach arrays that are positioned uniformly along the first width and the second Halbach array comprises multiple different Halbach arrays that are positioned uniformly along the second width.

9. The device of claim 7, wherein the first Halbach array comprises multiple Halbach arrays that are positioned asymmetrically along the first width and the second Halbach array comprises multiple different Halbach arrays that are positioned asymmetrically and complementary along the second width.

10. The device of claim 1, wherein the first portion comprises opposing first and second surfaces that extend from a first sidewall to a second sidewall and the second portion comprises opposing first and second surfaces that extend from a first sidewall to a second sidewall.

11. The device of claim 10, wherein the first Halbach array is arranged in a first group proximate to the first sidewall of the first portion and a second group proximate to the second sidewall of the first portion and the second Halbach array is arranged in a first group proximate to the first sidewall of the second portion and a second group proximate to the second sidewall.

12. The device of claim 11, wherein the first group of the first portion and the first group of the second portion are complementary and the second group of the first portion and the second group of the second portion are complementary.

13. The device of claim 12, wherein the first group of the first portion and the first group of the second portion are dissimilar to the second group of the first portion and the second group of the second portion.

14. The device of claim 10, wherein magnetic forces between the first portion and the second portion are greater when the first surface of the first portion is aligned with the first surface of the second portion than when the first surface of the first portion is aligned with the second surface of the second portion.

15. A device, comprising:
a first portion that includes a first elongate magnetic hinge sub-assembly encapsulated in a first end of the first portion;
a second portion that includes a second elongate magnetic hinge sub-assembly encapsulated in a first end of the second portion; and,
the first and second elongate magnetic hinge sub-assemblies biasing the first ends together while allowing the first and second portions to be rotated through a range of rotations.

16. The device of claim 15, wherein the first elongate magnetic hinge sub-assembly comprises a magnet and the second elongate magnetic hinge sub-assembly comprises a magnet or wherein the first elongate magnetic hinge sub-assembly comprises a magnet and the second elongate magnetic hinge sub-assembly comprises a ferromagnetic material.

17. The device of claim 15, wherein the first elongate magnetic hinge sub-assembly comprises first correlated magnets and the second elongate magnetic hinge sub-assembly comprises second correlated magnets.

18. The device of claim 15, wherein a profile of the first portion when viewed transverse to the first elongate magnetic hinge sub-assembly is the same as a profile of the second portion when viewed transverse to the second elongate magnetic hinge sub-assembly.

19. The device of claim 15, wherein a profile of the first portion when viewed transverse to the first elongate magnetic hinge sub-assembly is different than a profile of the second portion when viewed transverse to the second elongate magnetic hinge sub-assembly.

20. A system, comprising:
a first device that includes a first elongate magnetic hinge sub-assembly that is rotationally secured proximate to a first end of the first device;
a second device that includes a second elongate magnetic hinge sub-assembly proximate to a first end of the second device; and,
the first and second elongate magnetic hinge sub-assemblies configured to create a magnetic force that biases the first ends together while allowing the first and second devices to be rotated through a range of rotations while the first elongate magnetic hinge sub-assembly rotates independently of the first device.
